(19) United States
(12) Patent Application Publication
(10) Pub. No.: US 2017/0119617 A1
(43) Pub. Date: May 4, 2017

(54) HEAD AND SCALP DEVICE AND USES THEREOF

(71) Applicants: Julie Bargowski, (US); Magdalena Cilella, (US)

(72) Inventors: Julie Bargowski, Park City, UT (US); Magdalena O Cilella, Chicago, IL (US)

(21) Appl. No.: 15/316,919

(22) PCT Filed: Jun. 11, 2015
(86) PCT No.: PCT/US15/35436

§ 371 Date: Dec. 7, 2016

Related U.S. Application Data
(60) Provisional application No. 62/010,603, filed on Jun. 11, 2014.

(51) Int. Cl. A61H 7/00; A45D 34/04; A45D 19/02

(52) U.S. Cl. CPC A61H 7/003; A45D 19/02; A45D 34/04; A45D 2019/0033

(57) ABSTRACT

The present invention relates to devices and methods for cleansing and or conditioning head and scalp, while simultaneously massaging the head and scalp.

### RELATED APPLICATIONS

The present patent document claims the benefit of the filing date under 35 U.S.C. §119(e) of Provisional U.S. Patent Application Ser. No. 62/010,603, filed Jun. 11, 2014, which is hereby incorporated by reference.

### BACKGROUND

The present invention relates to devices for cleaning, conditioning and/or massaging head and scalp.

Head massagers are known in the art.

For example, van der Landle in U.S. Pat. No. D672,049 illustrated an alien head massager; Krenkler in U.S. Pat. No. D700,352 illustrated a head massager with cone shaped handle; and Friedland in U.S. Pat. No. 7,186,228 described a head massager with a vibration motor included with the head massager.

However, there still exists a need for improved head massaging devices that may further be used for cleansing and conditioning. Such improved devices may be beneficial for use by children and adults to aid in better cleansing of the scalp during showering/bath, children and adults with disabilities resulting in inability to flex fingers or hands, such as muscular disabilities fine motions with their fingers and hands; as well as elderly with limited mobility and flexibility in their fingers, hands and arms.

As such, improved devices and methods for head and scalp cleansing and massaging for use with children and adults, and especially children and adults with certain disabilities as well as elderly are desirable.

### SUMMARY

The present invention relates to devices for cleaning, conditioning and/or massaging head and scalp.

Certain embodiments relate to a device that can aid in cleansing and conditioning of the head and scalp, while simultaneously massaging the head and scalp.

One embodiment relates to a head and scalp cleansing, conditioning and massaging device that includes a top device part and a bottom device part. The top device part comprises a receptacle defining a cavity and adapted to contain at least one of a cleansing fluid and conditioning fluid, the receptacle having a top end and a bottom end, and a malleable receptacle cap adapted to at least partially enclose the receptacle. The bottom device part comprises a bundle of flexible rods having a top end and a bottom end, wherein the top end of the bundle of the rods is secured and in fluid communication with the cavity of the receptacle and the bottom end of bundle of the rods is free. The device may also include a dispenser pump associated with the top end of the receptacle. Alternatively, the top end of the receptacle may include an opening and an opening cover. The device may be adapted to be re-filled with the at least one of cleansing fluid and conditioning fluid through the opening. The receptacle may include a replaceable cartridge containing at least one of the cleansing fluid and conditioning fluid. In the device, at least one of the rods comprises at least one exit port. The exit port may be positioned at the bottom end of the at least one of the flexible rods. The exit port may be an opening at a tip of the flexible rod. Alternatively, at least one of the flexible rods may include multiple exit ports. The exit ports may be arranged around the circumference of the at least one of the flexible rods. The receptacle is adapted to release the at least one of the cleansing fluid and conditioning fluid upon application of pressure to the top device part. The cap may be in a shape of a princess, an octopus, a jellyfish, a shark, a dolphin, a wizard, a mermaid, seaweed, or a geometric figure. The bundle of flexible rods may include rods of identical lengths. Alternatively, the bundle of flexible rods comprises rods of at least two different lengths, or at least three different lengths. The top device part may be sized to securely fit into a palm of a child's hand. The top device part may be adapted to be squeezed by a young child, a child or adult with hand muscle disabilities, or elderly. The at least one of the top device part and the bottom device part may be adapted to change color upon exposure to water temperature lower than about 36° C. and or upon exposure to water higher than about 38° C. Alternatively, the device may include a temperature sensitive element that is adapted to change color at a temperature lower than 36° C. and higher than about 38° C. The bottom end of the at least one of the flexible rods may be rounded and adapted for massaging of the scalp and head. The top device part may be detachable from the bottom device part. The device may also be adapted to include an extension detachably connected to the top device part. The device may further include a hanger. The device may also be adapted to be placed into packaging. In the device, the fluid may further include an over-the counter and or prescription medicine for treatment of prevention of dandruff, scalp psoriasis, cradle cap, and Seborrheic Dermatitis.

Certain embodiments relate to the use of the head and scalp cleansing, conditioning and massaging device by a subject having limited mobility of flexibility of the fingers hand.

Certain further embodiments relate to the use of the head and scalp cleansing, conditioning and massaging device by a subject unable to make fine motions with the fingers.

Certain further embodiments relate to the use of the head and scalp cleansing, conditioning and massaging device an elderly subject.

Certain further embodiments relate to a kit including the head and scalp cleansing, conditioning and massaging device and packaging adapted to contain the scalp and head cleansing, conditioning and massaging device.

Certain other embodiments relate to a method of washing, conditioning or both a head and scalp with simultaneous massaging of the head and scalp that includes applying pressure to the top device part and thereby releasing the at last one of the cleansing fluid and conditioning fluid into the flexible rods and through the rods onto the scalp and head and washing the head and scalp with simultaneous massaging of the scalp.

These and other features and advantages of the invention will become apparent upon consideration of the following detailed description of the presently preferred embodiments, viewed in conjunction with the appended drawings.

### BRIEF DESCRIPTION OF THE DRAWINGS

FIG. 1 depicts a schematic drawing of the device for cleansing, conditioning and or massaging the scalp and head.

FIG. 2 depicts a schematic drawing of the device for cleansing, conditioning and or and massaging the scalp and head and the close-up view of the features of the cap.

FIG. 3 depicts a schematic drawing of the device for cleansing, conditioning and or and massaging the scalp and head with a detailed illustration of the top device part.

FIG. 4 depicts a schematic drawing of the device for cleansing, conditioning and or and massaging the scalp and head with a detailed illustration of the top and bottom device part.

FIG. 5 depicts a schematic illustration Section F-F of FIG. 4 of the free ends of the rods including exit ports.

FIG. 6 depicts another schematic illustration of the free end of a flexible rod.

FIG. 7 depicts a schematic drawing of the device for cleansing, conditioning and or and massaging the scalp and head.

FIG. 8 depicts a schematic drawing of the device for cleansing, conditioning and or and massaging the scalp and head and packaging.

### DETAILED DESCRIPTION

The present invention relates to devices and methods for cleansing and or conditioning head and scalp, while simultaneously massaging the head and scalp.

A scalp and head cleansing, conditioning and or massaging device useful in the practice of the present invention comprises two parts, which may be integral with each other or separate from each other, but adapted to be connected and in fluid communication with each other when in use.

A scalp and head cleansing and massaging device may be especially desirable: (1) for children and adults to aid in better cleansing of the scalp during showering and/or bathing while simultaneously massaging the head and scalp; (2) for children and adults with disabilities such as inability to make fine motions with their fingers and hands or inability to flex their fingers or inability to lift their arms above their shoulders to aid in better cleansing of the scalp during showering and/or bathing while simultaneously massaging the head and scalp; (3) for elderly with limited mobility and/or flexibility in their fingers and or inability to lift their arms above shoulders to aid in better cleansing of the scalp during showering and/or bathing while simultaneously massaging the head and scalp; (4) as a sensory tool air for those children and adults with sensory issues; and (5) for pets.

The device may be designed for use at home, hair salons, hospitals, care centers, therapy centers, assisted living centers, homes for elderly, and pet shops or hospitals.

The device may be designed for use during therapy, such as during physical therapy or occupational therapy.

Generally, a device that includes (i) a top device part that comprises a receptacle defining a cavity adapted to contain a fluid, the receptacle having a top end and a bottom end, and a malleable receptacle cap adapted to at least partially enclose the receptacle; and (ii) a bottom device part comprising a bundle of flexible rods having a top end and a bottom end, wherein the top end of the bundle of the rods is secured and in fluid communication with the cavity of the receptacle and the bottom end of bundle of the rods is free, is described herein.

A. The Top Device Part

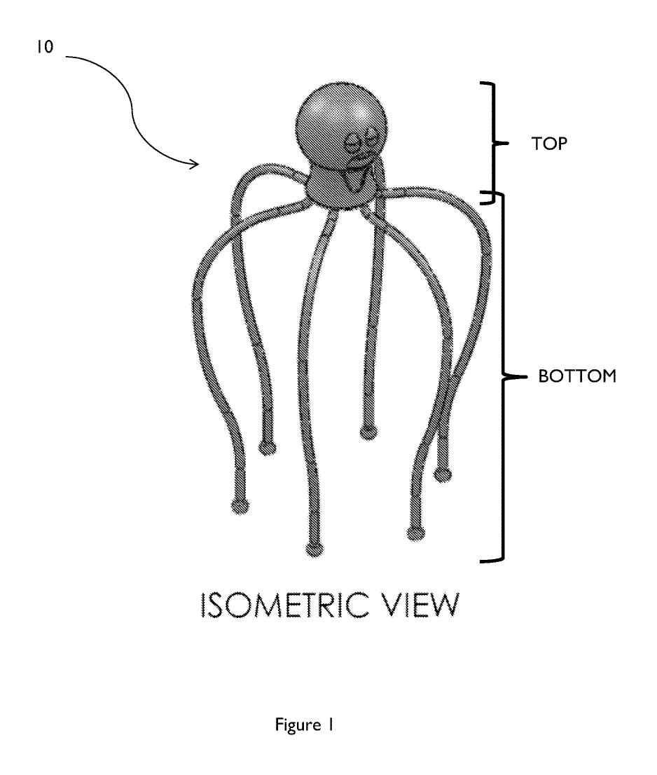

Referring to FIG. 1, the scalp and head cleansing, conditioning and massaging device 10 useful in the practice of the present invention comprises two parts: a top device part 20 and a bottom device part 30. The top part 20 of the cleansing, conditioning and massaging device 10 is designed to securely fit into a palm of a user's hand and is adapted to be squeezed by the user. In certain embodiments, where the user is a young child, the top device part may be smaller in size as compared to the top device part that may be intended for use by an adult. Specifically, the top device part may be sized so that a child can comfortably hold the top device part and be able to squeeze or apply pressure to the top device part and, as a result, push some of the cleansing and or conditioning fluid out of a receptacle holding the fluid.

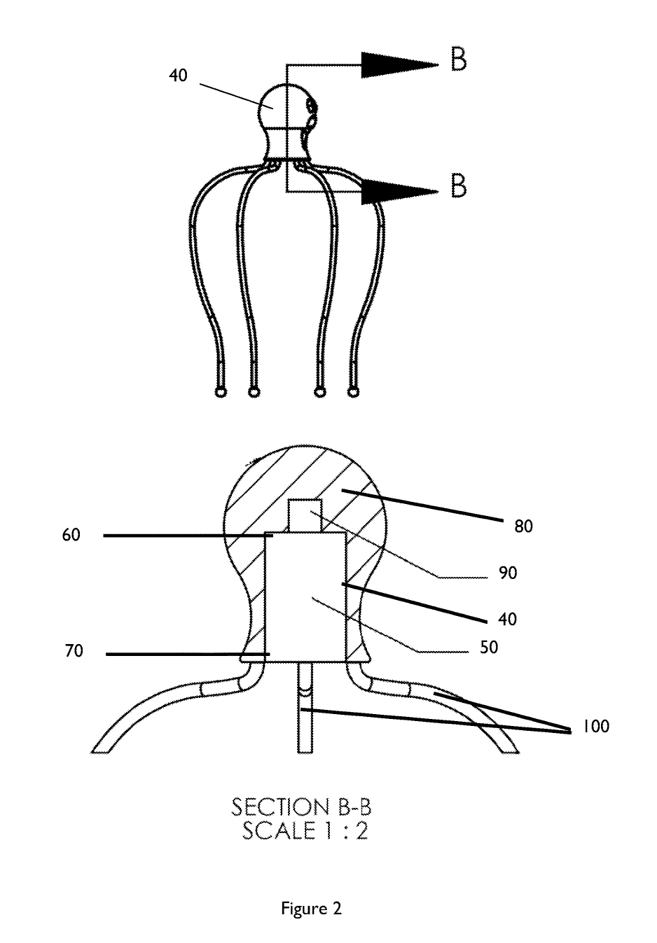

Referring to FIG. 2, the top device part 20 (Section B-B) comprises a receptacle 40 defining a cavity 50, where the receptacle 40 has a top end 60 and a bottom end 70 and is adapted to contain a fluid. The receptacle can be any suitable and a relatively small container adapted to contain a fluid. Examples of a receptacle include a small bottle, a tube, a cylinder, etc.

The fluid may be any fluid, including cleansing fluid, such as shampoo or soap, any hair or scalp conditioning fluid, such as hair conditioner, or a combination of the cleansing and conditioning fluids, such as shampoo and conditioner. The shampoo and/or shampoo with conditioner may be any shampoo and/or shampoo with conditioner commercially available and includes moisturizing, scented (fruit-scent, flower scent, herb scent, perfume scent, tree scent, etc.), lice-repelling or treating shampoo and/or conditioner, dandruff shampoo and or conditioner, psoriasis shampoo and conditioner (including, e.g., over-the-counter medicines such as salicylic acid and or coal tar), etc.

The fluid may also be a medical fluid, such as shampoo that may include an over-the-counter medicine or medicine prescribed by a physician.

For example, the shampoo and or conditioner may include a medicine for treating scalp psoriasis, such as anathralin, antimicrobials (used to treat bacterial or yeast infections associated with scalp psoriasis), a vitamin D derivative (e.g., calcipotriene), calcipotriene in combination with betamethasone dipropionate (a potent steroid), other topical steroids, and a vitamin A derivative (e.g., tazarotene).

In certain other embodiments, the shampoo and or conditioner may include a medicine to treat or prevent any other scalp or hair conditions, e.g., dandruff, Seborrheic Dermatitis and/or cradle cap.

The dandruff may be treated with preparations including, e.g., coal-tar preparations, such as Neutrogena T/Gel, Tegrin; Zinc pyrithione, such as Suave Dandruff Control, Pert Plus Dandruff Control, Head & Shoulders; Salicylic acid, such as T-Sal and Sebulex; Selenium sulfide, such as Selsun Blue; Ketoconazole, such as Nizoral A-D available as a 1% over-the-counter shampoo and a 2% prescription-strength shampoo.

To treat cradle cap, the shampoo and/or conditioner may include baby oil or mineral oil.

In certain further embodiments, the shampoo and or conditioner may include agents or medicines to enhance and or improve scalp hair growth.

The top device part 20 also includes a receptacle cap 80 adapted to at least partially enclose the receptacle 40. In certain embodiments, the receptacle cap 80 is adapted to completely enclose the receptacle 40. As used herein, the term “cap” refers to a protective or decorative lid or cover for an object, such as the receptacle (e.g., a bottle, tube, container, etc.). The receptacle cap 80 may be removable or may be permanently disposed on the receptacle 40. Preferably, the receptacle cap 80 tightly encloses the receptacle 40. The cap 80 may be made from any suitable soft, malleable and flexible material including, for example, plastic or rubber or fabric (e.g., fabric coated with water resistant or protective covering). The receptacle cap 80 is preferably soft, squeezable and or squishy to the touch. The receptacle cap may also have a “sticky” or “gooey” feel and not “slippery” to it to ensure that it is not easily dropped by the user in the shower or bath.

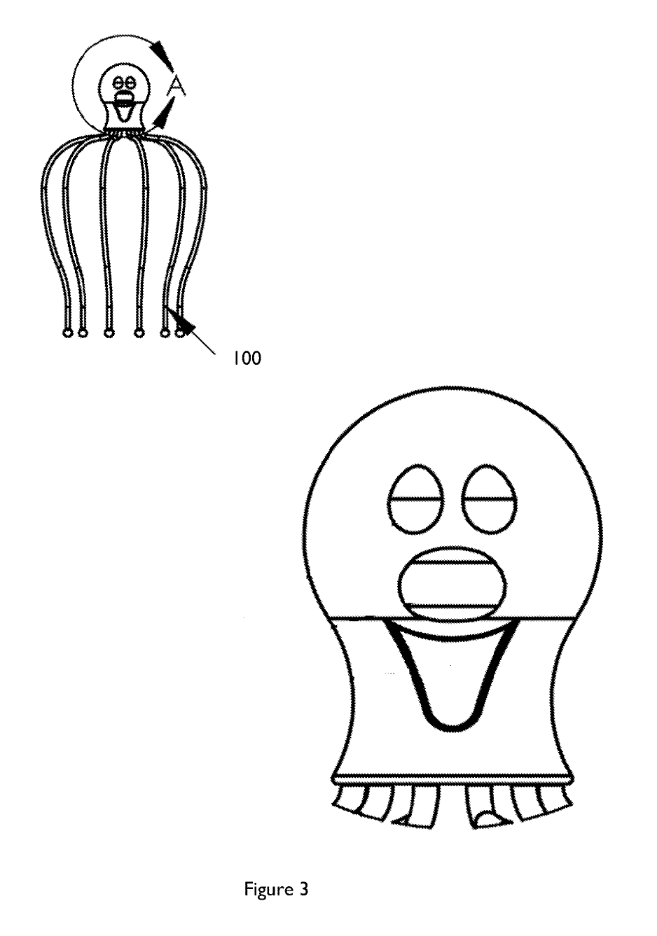

The shape and size of the receptacle cap can vary depending on the size of the top device part, including the receptacle. The size may also vary depending on the intended user (e.g., a child v. adult). For example, the receptacle cap 80 can be sized to tightly fit over the receptacle 40 and into a hand of a small child. In other embodiments, the receptacle cap 80 may be sized to fit over the receptacle 40 and into a hand of an adult. Depending on the intended user (i.e., a child v, adult), the shape of the receptacle cap can vary as well. Specifically, the receptacle cap intended for use by a child may be in a shape of a princess, mermaid, wizard, knight, solder, LEGO® figure, sea creature (fish, octopus, jellyfish, dolphin, whale, shark, etc.), dinosaur, animal (cat, dog, sheep, horse, pig, cow, wolf, etc.), bird (chicken, duck, owl), or any other desirable and suitable shape, etc. In certain embodiments, the cap may be in a shape of a geometric figure. An exemplary shape and design of the cap is shown in FIG. 3 and section A-A. As shown in FIG. 3, Section A-A, the cap may include facial features, smiley face, eyes, mouth, etc. that may be painted onto the cap. The cap may also include features of clothing, accessories, and physical features of animals, birds and fish (feathers, scales, etc.) that may be painted onto the cap.

In certain embodiments, the receptacle cap may not have any specific shape or design but simply be a cover for the hollow member.

In certain embodiments, as shown in FIG. 2, the device may include a dispenser pump 90 associated with the top end 60 of the receptacle 40. The dispenser pump allows the user to release the fluid from the receptacle 40 upon application of pressure to the pump. Dispenser pumps are known and widely used in the art.

In certain other embodiments, the top end 60 of the receptacle 40 may include an opening and an opening cover (not shown). The opening in the top end of the receptacle 40 allows the device to be re-filled with a fluid, as needed or necessary. The cover prevents the fluid spilling out of the receptacle.

In an alternative embodiment, the receptacle 40 can be a replaceable, single use cartridge containing at least one of the cleansing fluid and conditioning fluid, such as shampoo or shampoo with conditioner. The cartridges may be replaced as needed and/or necessary. The cartridges may include cartridges that are disposable once the cleansing fluid is used up. Alternatively, the cartridges may be refillable cartridges.

B. The Bottom Device Part

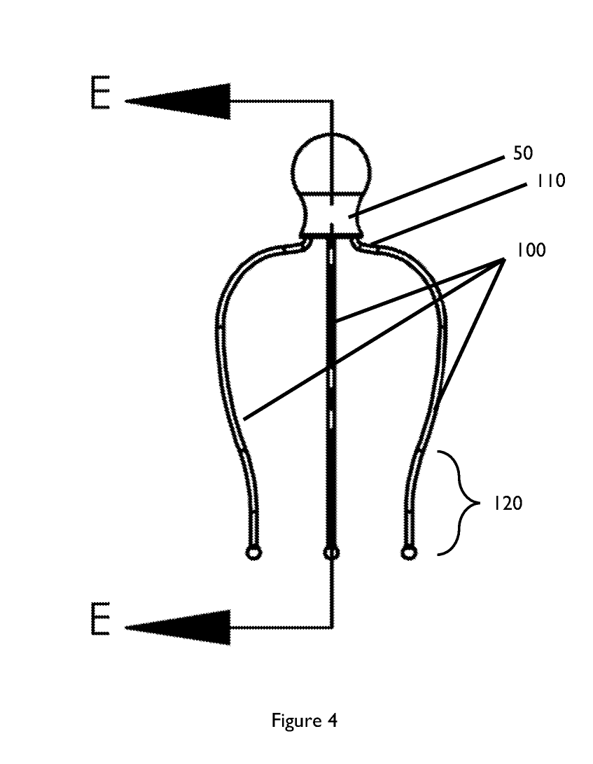

As shown in FIG. 1, the bottom part of the device comprises a bundle of flexible rods. Referring to FIG. 4, each of the rods 100 has a top end 110 and a bottom end 120. The top end 110 of the bundle of the flexible rods is secured and in fluid communication with the cavity of the receptacle 50, as shown in FIG. 4. The bottom end 120 of bundle of the flexible rods is free and adapted to massage the head and scalp.

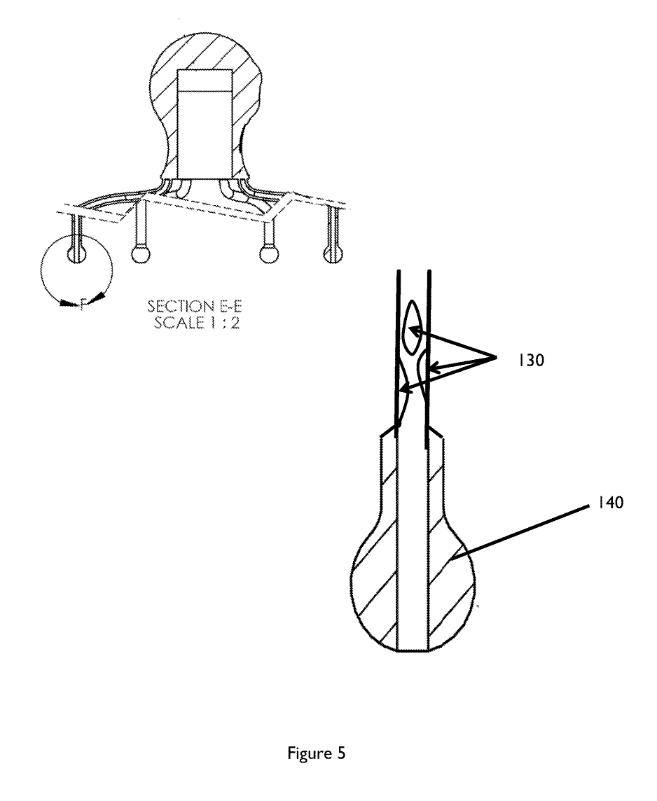

In certain embodiments, at least one of the flexible rods of the device for cleansing, conditioning and massaging head and scalp is hollow to receive the fluid from the receptacle and may include at least one exit port 130, as shown in FIG. 5, to deliver the fluid onto the head and scalp. In certain embodiments, about half of the flexible rods are hollow to receive the fluid from the receptacle and may include at least one exit port. In certain further embodiments, all of the rods are fluid delivery rods. In certain alternative embodiments, at least one of the flexible rods functions only as massaging rod; at least two of the flexible rods function only as massaging rods; at least half of the flexible rods function only as massaging rods.

In certain embodiments, the exit ports may be located throughout the entire length or just a portion of the delivery rods, e.g., the top and or the bottom portion of the flexible rods. In certain embodiments, the exits port may positioned at the bottom end of the at least one of the flexible rod. The exit port may be an opening at a tip of the delivery strut. In certain other embodiments, the at least one of the flexible rods includes multiple exit ports 130. The exit ports may be arranged around the circumference of the at least one of the rods.

In use, the receptacle is adapted to release the at least one of the cleansing fluid and conditioning fluid upon application of pressure to the cap, and or the receptacle, and or the dispenser pump, or a combination thereof. The fluid then moves from the receptacle into the delivery rods and becomes dispensed via the exit ports 130.

The number and sizing of the individual rods in the bundle is designed to be certain to provide coverage of the entire head surface of the user. In certain embodiments, the bundle of rods comprises rods of identical lengths and diameters. In certain further embodiments, the rods may be of varying lengths and diameters. Alternatively, the bundle of rods includes rods of at least two different lengths. In certain further embodiments, the bundle of rods comprises rods of at least three different lengths. Up to 20 different lengths may be suitable. The lengths of the rods can be in a range from about 0.5 cm to about 20 cm. The diameters of the rods may be in a range from about 0.1 cm to about 2 cm or more; preferably about 0.5 to about 1 cm.

The flexible rods can be made of any suitable and flexible materials, such as rubber, plastic, certain metals, such as copper, etc.

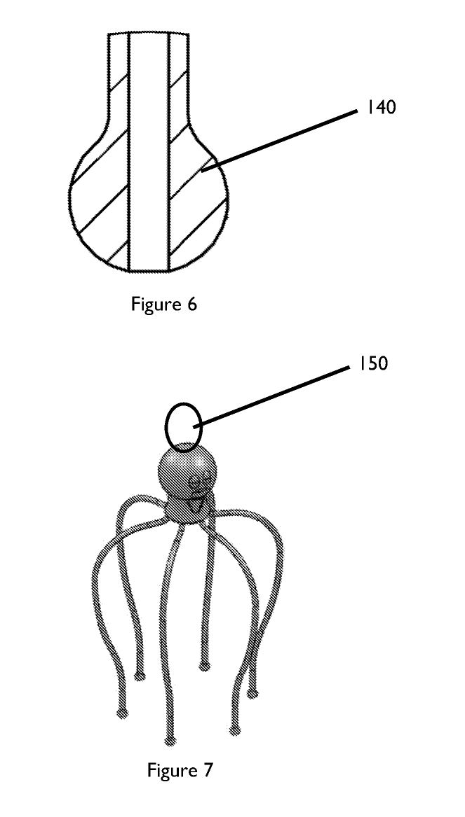

In certain further embodiments, the bottom end of the at least one of the flexible rods 110 may be rounded or provided with a protective end to insure no deleterious effects or injury and or adapted for massaging of the scalp and head, as shown in FIG. 6.

Additional Characteristics of the Device

In certain embodiments, the top device part may be adapted to be detachable from the bottom device part and from the bundle of the rods to allow for exchanging the top device part for a larger- or smaller-sized top device part or top device part of a different design or shape. In certain embodiments, the top device part may be adapted to be screwed into the bottom device part by rotating the two parts in opposite directions (e.g., the bottom end of the receptacle may include screw threads on its outer perimeter to accept the bundle of rods that may also include screw threads to fit into the receptacle, similarly to a jar and cap mechanism) or securely inserted into the bottom device part.

In certain embodiments, the cleansing, conditioning and massaging device may be transparent, be of a single color (yellow, red, orange, pink, green, blue, purple, navy, black, white, etc.) or include multiple colors. Different device parts may be transparent or have different colors depending on the design of the device.

One advantage of the present device is that it may be adapted to change color or light up, for example at certain, specified water temperatures. Specifically, for use with children, the device may be adapted to change color when the water temperature is too hot or too cold for a child. For example, the device may be adapted by having at least one of the top device part and the bottom device part be adapted to change color upon exposure to water temperature lower than about 36° C. and/or higher than about 38° C. Other temperatures may also be used.

In an alternative embodiment, the device may further include a separate temperature sensing part or element, such as a removable ring or a belt that may be associated with the device. The temperature sensing part may be associated with the device by attaching via a Velcro, or simply by stretching the element (e.g. temperature sensitive rubber ring) over any of the device parts. This temperature sensing element may also be made out of any suitable material including plastics or rubbers.

In certain further embodiments, the device may include an extension detachably connected to the top device part. The extension may be a handle intended for use by children or adults that may be unable to move their arms above their shoulders to be able to use the device without the extension.

In certain further embodiments, the device may also include a loop or a hanger 150 allowing for hanging the device in a shower or on a hook for drying between uses (FIG. 7).

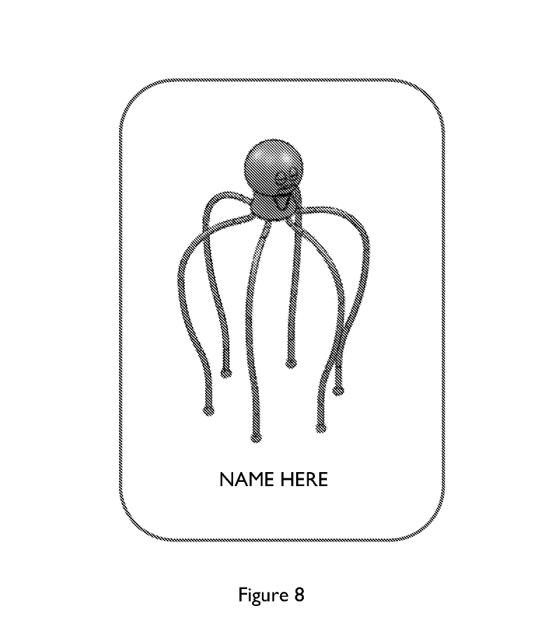

In certain further embodiments, the device of may be adapted to be placed into packaging (FIG. 8). The packaging may be designed so that it is appealing to an adult and or a child. The packaging may further include samples of shampoos and or conditioners. The packaging may include additional replacement receptacle caps. For example, the packaging may include the head and scalp cleansing, conditioning and massaging device with two receptacle caps, e.g., for use by two different users in one household, such as siblings.

Certain further embodiments relate to kits including the head and scalp cleansing, conditioning and massaging device described herein

In certain embodiments, the scalp cleansing, conditioning and massaging device described herein may be packages with a comb and/or a brush or other hair accessories.

The kit includes the head and scalp cleansing, conditioning and massaging device and packaging adapted to contain the scalp and head cleansing, conditioning and massaging device (FIG. 8).

Certain further embodiments relate to a method of washing, conditioning or both a head and scalp with simultaneous massaging of the head and scalp using the device described herein, where the method includes applying pressure to the top device part and thereby releasing the at last one of the cleansing fluid and conditioning fluid into the flexible rods and through the rods onto the scalp and head and washing the head and scalp with simultaneous massaging of the scalp.

### Uses and Products

The device may be for use by a child or an adult at home, hospital, hair salon, etc.

The device may be for use by a subject having limited mobility of flexibility of the fingers or hands.

The device may be for use by a subject unable to make fine motions with the fingers.

The device may be for use by a subject with limited hand flexibility.

The device may be for use by a subject unable to lift arms above shoulders.

### Additional Embodiments

Certain embodiments relate to a head and scalp cleansing, conditioning and massaging device comprising 1) a top device part comprising (i) a receptacle defining a cavity adapted to contain at least one of a cleansing fluid and a conditioning fluid, the receptacle having a top end and a bottom end, and (ii) a malleable receptacle cap adapted to at least partially enclose the receptacle; and 2) a bottom device part comprising (i) a bundle of flexible rods having a top end and a bottom end, wherein the top end of the bundle of the rods is secured and in fluid communication with the cavity of the receptacle and the bottom end of bundle of the rods is free. The device further comprises a dispenser pump associated with the top end of the receptacle. The top end of the receptacle comprises an opening and an opening cover. The device is adapted to be re-filled with the at least one of the cleansing fluid and the conditioning fluid through the opening. The receptacle comprises a replaceable cartridge containing at least one of the cleansing fluid and the conditioning fluid. At least one of the rods is hollow and comprises at least one exit port. The exit port is positioned at the bottom end of the at least one of the flexible rods. The exit port is an opening at a tip of the flexible rod. At least one of the flexible rods comprises multiple exit ports, wherein the exit ports are arranged around the circumference of the at least one of the flexible rods. The receptacle is adapted to release the at least one of the cleansing fluid and the conditioning fluid upon application of pressure to the top device part. The cap has a shape selected from the group consisting of a shape of a princess, a shape of an octopus, a shape of a jellyfish, a shape of a shark, a shape of a dolphin, a shape of a wizard, a shape of a mermaid, a shape of seaweed, a shape of a geometric figure, or the like. The bundle of flexible rods comprises rods of identical lengths. Alternatively, the bundle of flexible rods comprises rods of at least two different lengths or at least three different lengths. The top device part is sized to securely fit into a palm of a child's hand. The top device part is adapted to be malleable and pliable by a young child. The at least one of the top device part and the bottom device part is adapted to change color upon exposure to water temperature lower than about 36° C. The at least one of the top device part and the bottom device part is adapted to change color upon exposure to water temperature higher than about 38° C. The device further comprises a temperature sensitive element that is adapted to change color at a temperature lower than 36° C. and higher than about 38° C. The bottom end of the at least one of the flexible rods is rounded and adapted for massaging of the scalp and head. The top device part is detachable from the bottom device part. The device is further adapted to include an extension detachably connected to the top device part or a hanger. The device is adapted to be placed into packaging alone or with other items, such as a comb or a brush. The at least one of the cleansing fluid and the conditioning fluid further comprises an over-the counter or a prescription medicine to prevent and or treat a condition selected from the group consisting of psoriasis, dandruff, cradle cap, and Seborrheic Dermatitis. The device is for use by a subject having limited mobility or flexibility of the fingers and hands. The device is for use by a subject unable to make fine motions with the fingers. The device is for use by a subject with sensory problems. The device if for use in therapy.

It is therefore intended that the foregoing detailed description be regarded as illustrative rather than limiting, and that it be understood that it is the following claims, including all equivalents, that are intended to define the spirit and scope of this invention.

1. A head and scalp cleansing, conditioning and massaging device comprising:
a) a top device part comprising:
i) a receptacle defining a cavity adapted to contain at least one of a cleansing fluid and a conditioning fluid, the receptacle having a top end and a bottom end, and
ii) a malleable receptacle cap adapted to at least partially enclose the receptacle; and
b) a bottom device part comprising:
i) a bundle of flexible rods having a top end and a bottom end,
wherein the top end of the bundle of the rods is secured and in fluid communication with the cavity of the receptacle and the bottom end of bundle of the rods is free.

2. The device of claim 1, further comprising a dispenser pump associated with the top end of the receptacle.

3. The device of claim 1, wherein the top end of the receptacle comprises an opening and an opening cover.

4. The device of claim 3, wherein the device is adapted to be re-filled with the at least one of the cleansing fluid and the conditioning fluid through the opening.

5. The device of claim 1, wherein the receptacle comprises a replaceable cartridge containing at least one of the cleansing fluid and the conditioning fluid.

6. The device of claim 1, wherein at least one of the rods is hollow and comprises at least one exit port.

7. The device of claim 6, wherein the exit port is positioned at the bottom end of the at least one of the flexible rods.

8. The device of claim 6, wherein the exit port is an opening at a tip of the flexible rod.

9. The device of claim 1, wherein at least one of the flexible rods comprises multiple exit ports, wherein the exit ports are arranged around the circumference of the at least one of the flexible rods.

10. The device of claim 1, wherein the cap has a shape selected from the group consisting of a shape of a princess, a shape of an octopus, a shape of a jellyfish, a shape of a shark, a shape of a dolphin, a shape of a wizard, a shape of a mermaid, a shape of seaweed, a shape of a geometric figure.

11. The device of claim 1, wherein the bundle of flexible rods comprises rods of identical lengths or variable lengths.

12. The device of claim 1, wherein the top device part is adapted to be malleable and pliable by a young child.

13. The device claim 1, wherein the at least one of the top device part and the bottom device part is adapted to change color upon exposure to water temperature lower than about 36° C. or higher than about 38° C.

14. The device of claim 1, further comprising a temperature sensitive element that is adapted to change color at a temperature lower than about 36° C. and higher than about 38° C.

15. The device of claim 1, wherein the top device part is detachable from the bottom device part.

16. The device of claim 1, wherein the device is for use by a subject having limited mobility or flexibility of the fingers and hands and by a subject unable to make fine motions with the fingers.

17. The device of claim 1, wherein the device is for use by a subject with sensory problems.

18. The device of claim 1, wherein the device is for use in therapy.

19. A kit comprising:
the head and scalp cleansing, conditioning and massaging device of claim 1; and
packaging adapted to contain the scalp and head cleansing, conditioning and massaging device.

20. A method of washing, conditioning or both a head and scalp of a subject with simultaneous massaging of the head and scalp of the subject using the device of claim 1, comprising:
applying pressure to the top device part and thereby releasing the at last one of the cleansing fluid and conditioning fluid into the flexible rods and through the rods onto the scalp and head of the subject;
washing the head and scalp with simultaneous massaging of the scalp.
